(19) United States
(12) Patent Application Publication
(10) Pub. No.: US 2019/0325705 A1
(43) Pub. Date: Oct. 24, 2019

(54) Royal Rush

(71) Applicant: Zynga Inc., San Francisco, CA (US)

(72) Inventors: Sean Leslie, San Francisco, CA (US); Kin Hang Chan, San Francisco, CA (US)

(21) Appl. No.: 15/961,847

(22) Filed: Apr. 24, 2018

(51) Int. Cl. G07F 17/32

(52) U.S. Cl. CPC G07F 17/3262; G07F 17/3269; G07F 17/3267; G07F 17/3276; G07F 17/3255

(57) ABSTRACT

Methods, systems, and computer programs for providing an option to a player to participate in a competition game of the online game includes monitoring a game play of an online game by a player to determine the player has reached a threshold level that qualifies the player to participate in a competition game. Upon determining the player is qualified, the player is assigned to a class and a division that includes other players that are participating in the competition game. A time period for the competition game is set and the player is enabled to participate in a plurality of game sprints during the time period. Each game sprint spans a sprint time and is associated with a game sprint score. A highest game sprint score of the player is determined from amongst the plurality game sprints. The highest game sprint score is used to rank the player in the division for the competition game.

### BACKGROUND

### 1. Field of the Invention

The present embodiments relate to methods for providing variations to an online game, such as online slot games, to entice the players to continue playing the online game.

### 2. Description of the Related Art

Online betting games have become very popular, including casino-style games, such as video slots, online poker, video poker, blackjack, etc. In order to make games more interesting, game providers try to offer alternatives within the game to increase their variability, challenges, and bonus games.

However, many of the online games simply simulate game experience of a player played in a casino, which makes these online games similar with little differentiation from each other, resulting in a lack of continued interest in the game.

Increasing the options available to a player in the game improves customer experience, which results in longer playing periods of engagement. Also, by improving customer experience, game providers may entice new players to play the game. Further, by providing additional game options, players may increase their bet amounts which may result in increasing purchases of game currency.

Game options are desired that improve customer satisfaction with the game. It is in this context that embodiments arise.

### SUMMARY

Methods, systems, and computer programs are presented for providing games with variations for improving user engagement. It should be appreciated that the present embodiments can be implemented in numerous ways, such as a method, an apparatus, a system, a device, or a computer program on a computer readable medium. Several embodiments are described below.

In one embodiment, a method includes an operation of monitoring game play of a player for an online game to determine the player has reached a threshold level that qualifies the player to participate in a competition game. A class is determined for the player based on a history of game play of the player. The player is assigned to a division of players, based on the class of the player. The division defines a group of players for participating in the competition game. A time period is set for the competition game. The method includes an operation of enabling the player to participate in a plurality of game sprints during the time period, wherein each game sprint is a game session during which a game sprint score is obtained. A highest game sprint score of the player is determined for the plurality of game sprints that were played during the time period. The highest game sprint score is used to define a current ranking of the player among the group of players in the division.

In another embodiment, a method includes an operation of monitoring game play of a player for an online game to determine current game state of the player. The current game state is used to detect the player reaching a threshold level of the online game that qualifies the player to participate in a competition game. A history of game play of the player is analyzed to determine a size of game winnings of the player collected during game play of the online game. A class is determined for the player based on the size of game winnings. The player is assigned to a division of players, based on the class of the player. The division defines a group of players for participating in the competition game. The player is enabled to participate in a plurality of game sprints during a time period set for the competition game. Each game sprint is a game session during which a game sprint score is obtained by the player. A highest game sprint score of the player is determined from among the game sprints scores received for the plurality of game sprints that were played by the player during the time period. The highest game sprint score defines a current ranking of the player among the group of players in the division.

In yet another embodiment, a non-transitory computer-readable storage medium includes program instructions for performing a method which provides option to a player to participate in a competition game. The storage medium includes program instructions for monitoring game play of a player for an online game to determine the player has reached a threshold level that qualifies the player to participate in the competition game; program instructions for determining a class for the player based on a history of game play of the player; program instructions for assigning the player to a division of players, based on the class of the player, wherein the division defines a group of players for participating in the competition game; program instructions for setting a time period for the competition game; program instructions for enabling the player to participate in a plurality of game sprints during the time period, wherein each game sprint is a game session during which a game sprint score is obtained; and program instructions for determining a highest game sprint score of the player from the game sprint scores received for the plurality of game sprints that were played by the player during the time period. The highest game sprint score is used to define a current ranking of the player in the competition game among the group of players in the division.

Other aspects will become apparent from the following detailed description, taken in conjunction with the accompanying drawings.

### BRIEF DESCRIPTION OF THE DRAWINGS

The embodiments may best be understood by reference to the following description taken in conjunction with the accompanying drawings.

FIG. 1 illustrates various modules of a game execution engine that executes on a game server to provide an option to a player to participate in a competition game of an online game, in accordance to one implementation.

FIG. 2 illustrates process operations of a method that is used to allow a player to participate in a competition game of an online game, in accordance to one implementation.

FIG. 3 illustrates process operations of a method for classifying a player into a division for a competition game of an online game, in accordance to one implementation.

FIG. 4 illustrates process operations of a method for dynamically ranking a player based on the player's participation in the competition game, in accordance to one implementation.

FIGS. 5A-5C illustrate a game flow process for a competition game, in accordance to one implementation.

FIG. 6 illustrates process flow of a game spin performed during a game sprint, in accordance to one implementation.

FIGS. 7A-7B illustrate process flow depicting an end of a game sprint, in accordance to one implementation.

FIGS. 8A-8B illustrate process flow depicting an end of an event (e.g., a competition game), in accordance to one implementation.

FIG. 9 illustrates process flow for depicting a final standing of a player in a competition game, in accordance to one implementation.

FIG. 10 illustrates an example classification for assigning to a player in accordance to qualifying bets of the player, in accordance to one implementation.

FIG. 11 illustrates an example game winnings payout for players in a division after successful completion of the competition game, in accordance to one implementation.

FIG. 12 illustrates an example hardware configuration of a system used for providing a player with an option to participate in a competition game, in accordance to one implementation.

### DETAILED DESCRIPTION

The following embodiments describe methods, systems, and computer programs for providing a player with options to participate in a competition game with other players and to determine a current rank of the player among the group of players that participate in the competition game. The current rank of the player is based on game scores the player obtained during the competition game. It will be apparent, that the present embodiments may be practiced without some or all of these specific details. In other instances, well-known process operations have not been described in detail in order not to unnecessarily obscure the present embodiments.

Broadly speaking, a player is provided with a user interface that allows the player to access an online game, such as an online slot game, an online betting game, etc., for game play from a cloud gaming system. An interactive option is provided in the online game that allows the player to participate in a competition game with other players. The interactive option, in some implementation, may be provided to the player upon determining that the player has the necessary skill set to compete. The eligibility of the player to compete may be determined based on a level the player has achieved in the online game. For example, when the player has reached a threshold level of the online game, the player may be eligible to participate in the competition game. Providing a threshold for eligibility allows the player to participate in a competition game with other players possessing comparable skill set, thereby making it more interesting and challenging to the player. In alternate implementation, the interactive option may be provided to the player based on their game winnings. In yet another implementation, the interactive option may be provided to all the players irrespective of the players' possessing necessary skill set or game winnings.

When the player is eligible to participate in the competition game, a class is determined for the player based on a history of game play of the player. Once a class is determined for the player, the player is assigned a division based on the class. The division defines a group of players that have similar skill set who have expressed an interest in participating in the competition game. Each competition game may be defined to span a common, pre-defined time period (e.g., 24 hours, 12 hours, etc.). Alternately, each competition game may be defined to have a distinct time period. For example, the competition game may be set for 4 hours or 2 hours or 1 hour and may depend on the interests of the players, time of the day/week, number of players expressing interest at a given time, game play habits of the players, etc. The competition game includes a plurality of game sprints. Each game sprint is defined by a sprint time that can be adjusted in pre-defined increments by each player, and is associated with a game sprint score. A highest game sprint score is determined from amongst the game sprints played by the player within the time period of the competition game and is used to rank the player in the competition game. The highest game sprint score is also used along with the class and the division for determining payouts to the players in the competition game. With a brief overview, details with reference to specific implementations will now be described with reference to the various drawings.

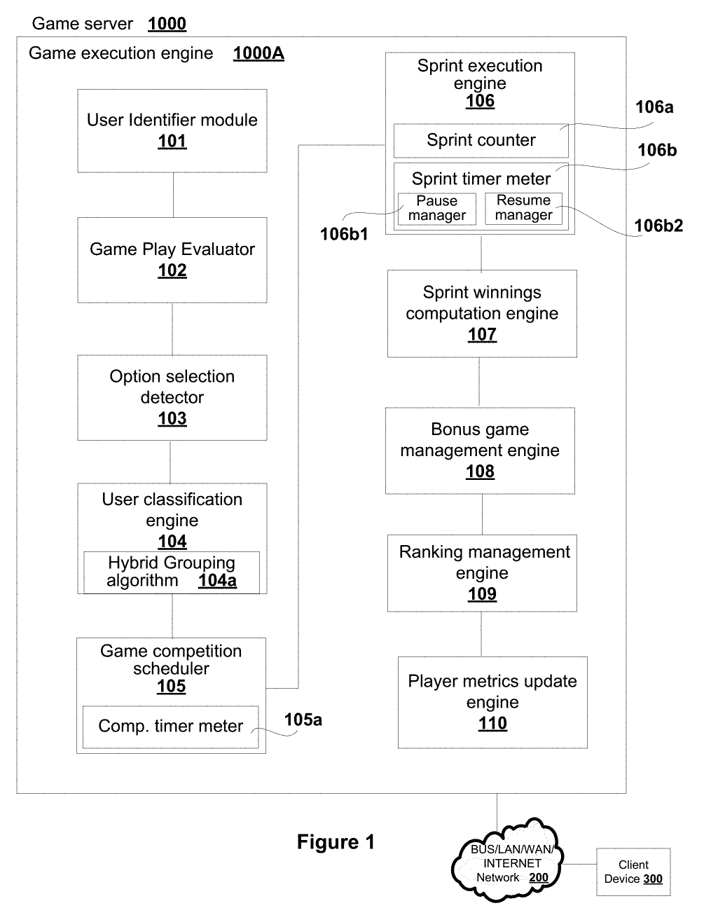

FIG. 1 illustrates the various modules within an online game execution engine executing on a game server that is used to provide an option to a player to participate in a competition game of an online game. The game server may be part of a network, such as a game cloud system, a local area network, wide area network, virtual private network, etc. The game server includes one or more processors, memory and other components to execute interactive applications, and to receive, process, compute, store, retrieve, and forward various data related to the interactive applications, such as an online game, in response to actions and interactions received from the player. The various modules of the online game execution engine illustrated in FIG. 1 are for illustration purposes and that fewer or additional modules may be included. In some implementations, some of the modules may be integrated into other modules leading to fewer modules.

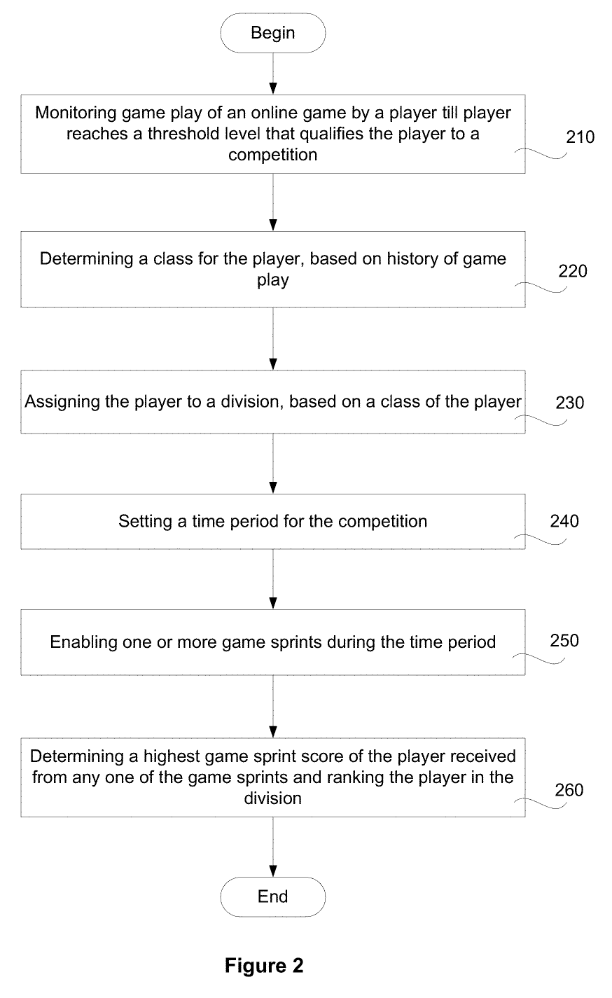

FIG. 2 illustrates an example flow of operations of a method for providing options to a player to participate in a competition game of an online video game, with other players. The online game execution engine identifies and authenticates a player, executes the online game (i.e., interactive application) in response to a request for game play from the player, updates the game state of the executing online game based on inputs provided by the player, evaluates the game play of the player, provides option to participate in a competition game, and ranks the player in accordance to the score obtained by the player in the competition game, when the player elects to play the competition game.

Referring simultaneously to FIGS. 1 and 2, the method begins at operation 210, wherein a online game execution engine 1000A executing on a game server 1000 of a cloud gaming system monitors game play of the online video game selected by a player for game play to determine when the player reaches a threshold level of game play that qualifies the player to participate in the competition game. The player may select the online video game for game play from a plurality of video games that are available for their user account. A user identifier module 101 detects the player accessing the user account on the cloud gaming system and authenticates the player by verifying a user identifier against a user database (not shown). The user account identifies a list of the various interactive applications, including the various online games, available to the player at the cloud gaming system. Upon successful authentication, the player is allowed to access the online game and begin game play of the online game. The online game includes multiple levels and may be a single-player or a multi-player video game.

As the player progresses through various levels in the video game, the player's skill level improves. The game play of the player is monitored by a game play evaluator 102. The game play evaluator 102 may monitor the game state of the online game of the player to determine when the player has reached a threshold level in the online game that qualifies the player to participate in the competition game. The player may reach the threshold level either in a single game play session or multiple game play sessions. When the player reaches the threshold level in the online game, the game play evaluator 102 provides an interactive option to the player to allow the player to participate in a competition game of the online game. In some embodiments, the interactive option may be provided as an interactive icon that is rendered alongside or as an overlay (e.g., such as an icon topper) at an icon of the online video game rendered at a user interface of a client device associated with the player. When the player selects the interactive option, an option selection detector 103 detects the user selection of the option and, in response, initiates the competition game.

As part of initiating the competition game, a user classification engine 104 of the video game execution engine identifies a plurality of classes defined for the competition game and selects a class from the identified plurality of classes for assigning to the player, as illustrated in operation 220. The plurality of classes may be defined for the competition game based, for example, on anticipated average bet size that can be placed by a plurality of players, with the highest class being associated with highest average bet size and a lowest class being associated with lowest average bet size. A hybrid grouping algorithm 104a of the user classification engine 104 may be used to obtain the game play metrics of the player for the online game maintained in game history log (not shown), use the game play metrics to determine average bet size of the player, and identify an appropriate class based on the player's average bet size.

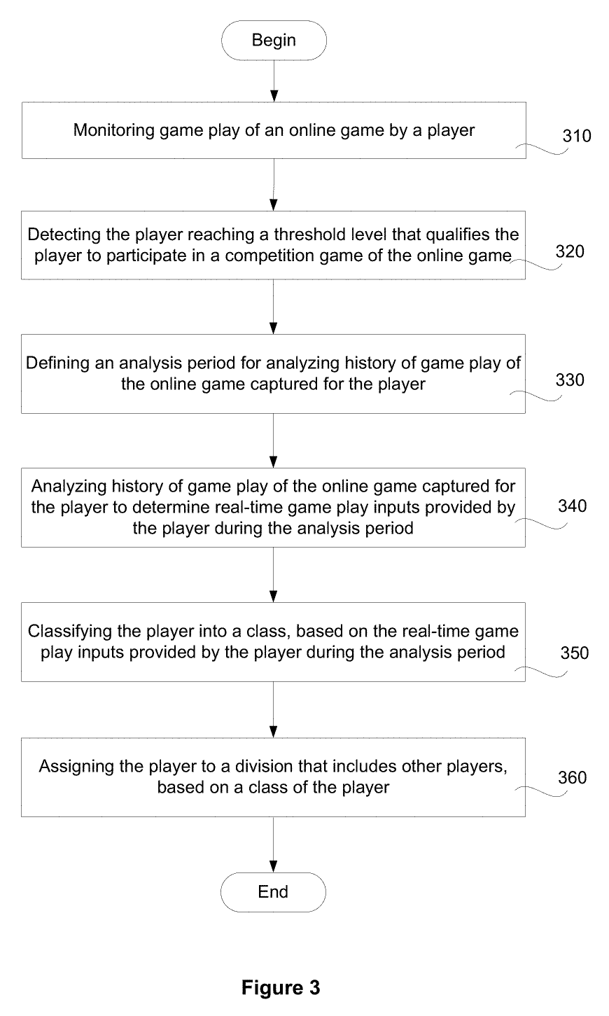

Once a class for the player is determined, the hybrid grouping algorithm 104a then identifies a division for placing the player in the competition game, as illustrated in operation 230. The placement of the player in a division, in some implementations, is based on skill level of the player determined by monitoring the game play of the player, with a higher division being associated with a higher skill level and a lower division being associated with a lower skill level. The function of the user classification engine 104 and of the hybrid grouping algorithm 104a in identifying a class and division for placing the player will be discussed in more detail with reference to FIG. 3.

Once the player is assigned to a class and a division, a game competition scheduler 105 sets a time period for the competition game, as illustrated in operation 240. The time period may be set to be a pre-defined time period (e.g., 24 hours, 12 hours, etc.,) that is common for all competition games or may be set prior to start of each competition game. A competition timer meter 105a keeps track of the different times the players access the online game for game play and also the time period of the competition game for each player in each division of the competition game. During the time period set for the competition game, a sprint execution engine 106 is engaged to enable the player to perform a plurality of game sprints, as illustrated in operation 250. A sprint counter 106a assigns a game sprint identifier to each game sprint the player is engaged in to keep track of the game play during the game sprint. Each game sprint is associated with a sprint time that extends for a pre-defined duration of time (e.g., a short duration of 60 seconds, 90 seconds, etc.) and a sprint timer meter 106b keeps track of the sprint time of each game sprint.

Each game sprint is a game session that allows the player to complete as many game turns or game play of the online game as possible. For example, for an online slot game, a game turn may be a spin of a slot wheel. Similarly, for an online roulette game, the game turn may be completion of the ball spin. The sprint execution engine 106 keeps track of game play of each game turn and determines game winnings for the game turn based on the result of the game turn. The game winning for each game turn within the game sprint is provided to a sprint winnings computation engine 107. The sprint winnings computation engine 107 receives the game winnings from each game turn of the game sprint played by the player and computes a game sprint score for the game sprint of the player as a function of the game winnings from each game turn.

The game execution engine 106 allows the player to perform as many game sprints as possible within the time period set for the competition game with each game sprint played by the player being associated with a corresponding game sprint score. At the end of the time period for the competition game, the sprint winnings computation engine 107 analyzes the game sprint scores for all the game sprints played by the player during the competition game and identifies a highest game sprint score associated with a particular game sprint, as illustrated in operation 260. The highest game sprint score of the player is provided to a ranking management engine 109. The ranking management engine 109 uses the highest game sprint scores from all the players to rank the players in the division. The highest game sprint score of the player is also provided to a player metrics update engine 110 to determine game winnings of the player. The player metrics update engine 110 may use the game sprint score of the player and the class, the division assigned to the player and determine the game winnings and the relative ranking of the player within the division. The game play metrics update engine 110 updates the player metrics of each player participating in the competition game with the game winnings, the relative ranking, etc.

The players in each division may play the competition game at different times (i.e., asynchronously). As a result, the game play of each player in the competition game is continuously monitored by the various modules of the online game execution engine 1000A and the relative ranking, player metrics of each player are dynamically updated.

In addition to enabling the player to participate in a plurality of game sprints, the online game execution engine may also provide a bonus game option to the player to play a bonus game to further improve their game winnings during the competition game. A bonus game management engine 108 may be engaged to provide the bonus game option to a player during the competition game. In some implementation, the sprint execution engine 106 or the sprint winnings computation engine 107 may trigger a signal to the bonus game management engine 108 to provide an option to the player for playing a bonus game. In some implementations, the signal for the bonus game may be triggered during a game sprint by the sprint execution engine 106 or the sprint winnings computation engine 107 based on the game winnings or game inputs (e.g., bets) of the player during the game sprint or during the competition game. For example, if the sprint winnings computation engine 107 detects that the game winnings of the player during the game sprint is below a threshold level or the overall game winnings of the player are dwindling, or if the sprint execution engine 106 detects that the player has placed a lot of bets in the competition game, the respective module may trigger the bonus game for the player to help the player to improve his game winnings. In alternate implementations, the signal for the bonus game may be triggered based on the game level of the player or just randomly.

The signal would cause rendering of a bonus game option on a user interface of a client device used by the player to play the bonus game. The bonus game option may be provided during a game sprint. When the user selects the bonus game option, the bonus game management engine 108 initiates the bonus game.

The bonus game management engine 108 works hand-in-hand with the sprint execution engine 106 to enable the player to participate in the bonus game. For example, upon detecting the player selecting the bonus game option, the bonus game management engine 108 sends a signal to sprint execution engine 106 to pause the game sprint that the player is currently engaged in so that the bonus game can be started for the player. A pause manager 106b1 of the sprint execution engine 106 processes the signal by saving a game state of the current game sprint and pauses the sprint time of the current game sprint. Upon receiving an indication that the current game sprint of the player has been paused, the bonus game is then initiated by the bonus game management engine 108. Similar to the game sprint, the bonus game is associated with a bonus game time within which the player is allowed to perform as many game turns as possible. The bonus game management engine 108 monitors the bonus game played by the player, accumulates the bonus game winnings and provides the accumulated bonus game winnings to the sprint winnings computation engine 107 to update the game winnings for the current game sprint. The bonus game management engine 108 then sends a signal to the sprint execution engine 106 to resume the current game sprint. A resume manager 106b2 receives the signal from the bonus game management engine 108, retrieves the game state of the game sprint that was saved by the pause manager 106b1, and resumes the current game sprint from the time the current game sprint was paused. Any game winnings obtained by the player after resumption of the current game sprint is provided to the sprint winnings computation engine 107 to update the game sprint score for the current game sprint.

The competition game provides an advantage over the online game, in that the player is allowed to experience a variation of the online game that enables the player to compete with other players having similar skill set to determine the overall standing of the player amongst the players. Some of the technological improvements and advantages of the various implementations are outlined below. An advantage of the various implementations includes providing variations of an online game to entice players to continue playing and providing them with an appearance of luck, thereby increasing the usability amongst users. The variations provided in the online game (e.g., multiple game sprints within a fixed period of time, unique way of grouping players, etc.,) allows the users to experience different “flavors” of an online game making the online game more interesting to the users, thereby increasing the users engagement with the online game. A technological advantage includes implementing the competition game via a distributed network with a server managing asynchronous game plays during fixed period of time defined for the competition and continually managing the ranking of the players regardless of when the players access the online game. The competition game is set up to allow a player to perform multiple game sprints within the time period set for the competition game, with each game sprint defined by a sprint time. Further, the sprint time of a game sprint can be varied by the player based on their game betting intensity in the online game. For instance, the player may be able to increase sprint time of a game sprint, which is usually pre-defined, by defined time increments by placing bets. For example, the sprint time of each game sprint may be set to 90 seconds and the player may be able to increase the sprint time in increments of 30 seconds by placing bets for the game sprint with the overall size of the bets determining the number of increments added to the sprint time for a game sprint. For example, the sprint game may be set up to add 30 seconds (i.e., pre-defined increment) to the sprint time of a game sprint by placing a 20,000 unit bet. Thus, if the player bets 60,000 units for a game sprint, then the sprint time for the game sprint would increase to 3 minutes (90 seconds of initial sprint time and 3×30 seconds increment for the 60,000 unit bet placed by the player for the game sprint, for a total of 180 seconds or 3 minutes). In some implementations, the player may be provided with an option to place a bet for all game sprints that the player is likely to play in the competition game, at the beginning of the competition game. In other implementations, the player may be provided an option to place the bet for each game sprint individually. It should be noted that the player and user are used interchangeably in this application to refer to a person that has a user account on a cloud gaming system and has access to select and interact with one or more interactive applications (e.g., online games).

The players are assigned to different divisions for playing in the competition game based on their real-time game play input so as to allow the player to compete with other players that have similar game playing skills. Additional variations may be provided in the online game by randomly varying the assignment of the player to different divisions within each class so as to allow the player to experience playing with players having different skill sets. Additional advantages may be envisioned by one skilled in the art after reading the various implementations described herein.

FIG. 3 provides operations of a method for setting up the player to a division to enable the player to participate in a competition game defined for the online game, in one implementation. The method begins at operation 310 wherein game play of an online game by a player is monitored. The online game may be an online slot game, online betting game, etc., and may include multi-level of game play and can be played by multiple players either synchronously or asynchronously. The player may select the online game for game play from a plurality of online games that are available to a user account of the player maintained in a cloud system.

A game execution engine available on the cloud system executes the online game on a game server of the cloud gaming system and adjusts current game state of the online game, based on input provided by the player during game play. The game play for the online game of the player is monitored to determine various game play metrics related to the player and the online game, including current game state of the player for the online game, current level of the game the player has achieved, current winnings of the player, various bets placed by the player during game play of the online game, etc.

During game play of the online game, the player's game play is continuously evaluated by comparing a current level of the online game achieved by the player to a pre-defined threshold level set for the online game to determine if the player qualifies for a competition game defined for the online game, as illustrated in operation 320. The online game may include 10 levels and the threshold level may be set at level 5. Thus, during the course of game play of the player, when the player reaches at least level 5 of game play of the online game, the player is considered to be eligible to participate in a competition game of the online game. The online game execution engine, upon detecting that the player has achieved the threshold level may responsively provide an option for the player to participate in the competition game defined for the online game. The option may be provided at a user interface on a client device associated with the player used to provide input to the online game. The option may be provided as an icon overlay, an icon that is rendered alongside an icon of the online game, a button, etc. User selection of the option will initiate the competition game for the player.

As part of initiating the competition game for the player, a user classification engine of the online game execution engine assigns the player to a class and a division using a hybrid grouping algorithm. In order to determine a class for the player, the hybrid grouping algorithm analyzes player metrics specified within a game history log to determine types of bets, frequency of bets, sizes of bets placed by the player, levels where the bets were placed, etc. An analysis period is defined for analyzing the history of game play of the online game for the player, as illustrated in operation 330. A game history log maintained for the online game may include game play details covering an extended period of time, of all players. The analysis period identifies a time range to use for identifying related game play details of the player from the game history log maintained for the online game.

The identified game play details from the game history log are analyzed to determine the player metrics of the player during the analysis period, and eventually the average size of bet placed by the player, as illustrated in operation 340. The game play details include the real-time game play inputs provided by the player, and are used to determine types of bets placed, frequency of bets placed, sizes of bets placed by the player at different times and for different levels during game play of the online game. The hybrid grouping algorithm uses the game play inputs to identify the sizes of various bets placed by the player for the online game during the game play sessions covering the analysis period (e.g., 7 days) and determines an average size of bet for the player for the online game.

Based on the average bet size associated with the player, a class from among a plurality of classes may be identified for the player for the competition game, as illustrated in operation 350. The plurality of classes is defined for the competition game based on the average size of bet placed by different players. Each class covers a range of bets, with the highest class associated with a highest average bet size and a lowest class associated with a lowest average bet size. Thus, the class is defined based on analysis of game play metrics of the player captured in the game history log.

When the game history log does not have sufficient history of game play for the online game of the player (e.g., the player selecting the online game for game play for the first time or has played only for a day or two within the 7 day analysis period), the hybrid grouping algorithm may use game winnings accumulated from current game play (i.e., a player's current “wallet” size) to determine the class and division for the player for the competition game. The hybrid grouping algorithm may compute a division qualifying bet as a percentage of the game winnings. For example, the division qualifying bet may be defined as a percentage (e.g., 4%, 5%, etc.) of the current wallet size of the player.

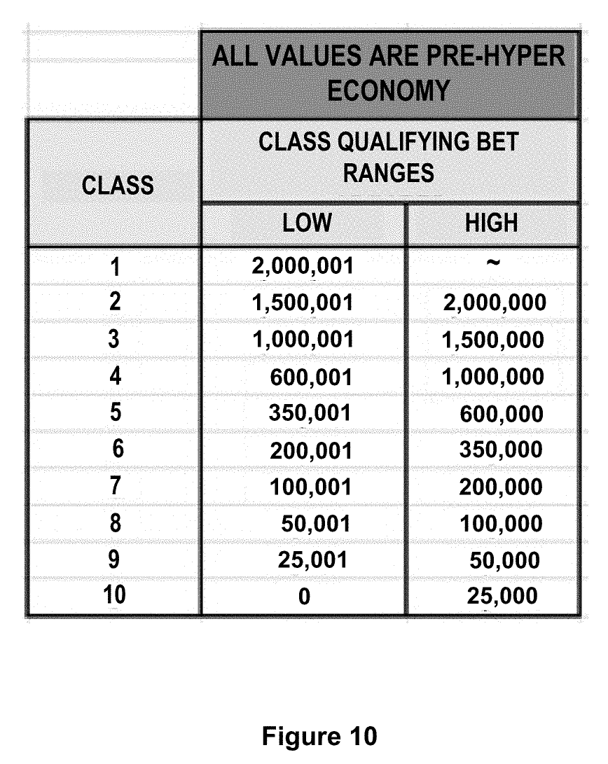

FIG. 10 illustrates an example list of classes that are defined for the competition game into which the players are placed, in one implementation. In the example illustrated in FIG. 10, 10 different classes (e.g., class 1 through class 10) are identified based on average size of bets placed by different players during game play of the online game over a pre-defined period (such as previous 7 days from the above example), with class 1 having a highest average size of bet (e.g., greater than 2 million game winning units), class 2 having the next average size of bet ranging between 1,500,001 and 2 million game winning units, class 3 having average size of bet ranging between 1,000,001 and 1,500,000 game winning units, and so on, and class 10 having a lowest average bet size (e.g., less than 25000 game winning units). Of course, the number of classes shown in FIG. 10 is for illustrative purposes and fewer or greater number of classes may be defined for the competition game.

Such classification of the players would make the competition that much more interesting to a player as the player is competing with other players having comparable game playing skills. In some implementations, each and every player that has achieved at least the pre-defined level in the game play of the online game may be automatically classified into respective divisions and, when the player selects the option to participate in competition game with other players, the classified player competes with other players from their own division. In other implementations, the player is classified as and when the player selects to participate in the competition game. Once the player is assigned to a class, a limited number of divisions are defined for classifying the players in each class.

Referring back to FIG. 3, the hybrid grouping algorithm (104a of FIG. 1) may assign the player to a division, based on the class into which the player is placed, as illustrated in operation 360. The hybrid grouping algorithm 104a may use the skill set acquired by the player during game play of the online game to assign the player to a division. There can be a plurality of divisions (e.g., 10 divisions represented by division A through division J) defined in each class for assigning the players of the competition game based on the skill sets possessed by the respective players, with players having highest skill set being assigned to the highest division and the players having the lowest skill set being assigned to the lowest division. In some implementations, the skill set of each player may be measured by the player's mastery of the online game determined by how fast the player completes each level, how quickly the player overcomes hurdles, how many turns or tools the player uses to overcome each hurdles, style of game play, etc. Of course, the aforementioned list of determining mastery is provided for illustration purposes only and should not be considered exhaustive or limiting. Fewer game play metrics or different ways of determining the skill set of the player or mastery of the online game may be engaged. Each division includes a plurality of players that have similar skill set so that players in each division are competing with other players with comparable skill set.

Depending on the class in which the player is placed, the player may be assigned to a specific division or may be assigned randomly to one of a plurality of divisions. For example, if the player is in the highest class (i.e., class 1), the hybrid grouping algorithm may identify the class level the player is assigned (i.e., highest class) and place the player in the highest division (e.g., division A). Similarly, if the player is in the lowest class (i.e., class 10), the hybrid grouping algorithm may place the player in the lowest division (e.g., division J). For the player who is in any one of classes 2 through 9, the hybrid grouping algorithm may place the player in a correspondingly ranked division or in a next higher division, in some implementations. For example, a player in class 2 (a second highest class) may be placed in division B (a second highest division) or division A (the next higher division to division B). Similarly, a player in class 3 may be placed in division C (comparable division number) or division B (next higher division to division C), and so on. In alternate implementations, for a player who is in any one of classes 2 through 9, the hybrid grouping algorithm may assign the player in a correspondingly ranked division or in a next lower division. In such implementations, a player in class 2 (a second highest class) may be placed in division B (a second highest division) or division C (the next lower division to division B), a player in class 3 may be placed in division C or division D (next lower division to division C), and so on.

The random assignment of the player in different divisions other than the highest and the lowest divisions may change from one competition game to the next. However, once the player is assigned to a division, the player remains in the division throughout a given competition game session. This type of grouping the player allows the player to have varied experience in the competition game by allowing the player to compete with other players having comparable skill set or higher skill set or lower skill set.

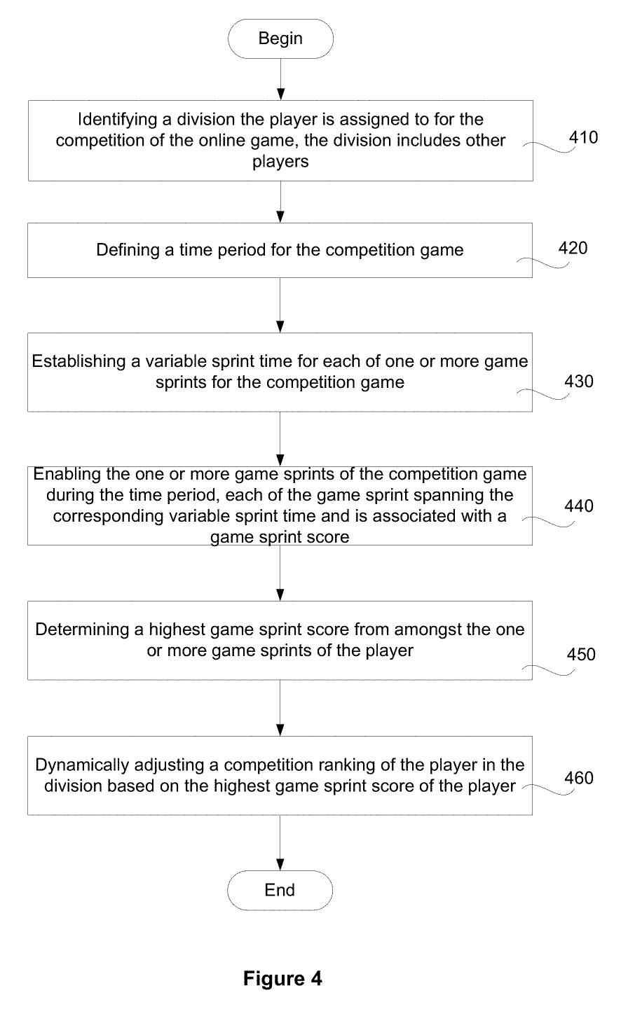

FIG. 4 illustrates example method operations for enabling the player to participate in the competition game, in one implementation. The method begins at operation 410, wherein a class and a division to which the player is assigned to for the competition game, is identified. Assigning the division to the player was discussed with reference to FIG. 3. Once the player is assigned a class and a division, the competition game may be initiated. The competition game may be played synchronously or asynchronously and the online game execution engine monitors the game play of each player in each division of the competition game and manages the ranking of the players in the respective divisions dynamically.

To begin the competition game, a time period for the competition game is set, as illustrated in operation 420. The time period may be set at the beginning of a competition game or may be a pre-defined time period that is common for all competition games played for the online game. For example, the time period of the competition game may be set to be 1 hour, 2 hours, 4 hours, 12 hours, 24 hours, etc. Once the time period of the competition game is set, the player is allowed to use the option and participate in the competition game. The competition game may be played asynchronously or synchronously. The asynchronous game play of the competition game provides more flexibility as it provides the players with a time period to play the competition game and not restrict the player to a specific time period.

Player selection of the option initiates the competition game. The competition game enables the player to participate in a plurality of game sprints within the time period set for the competition game. Each game sprint of the competition game is defined by a sprint time that can be varied based on game play inputs, such as bets, provided by the player for the corresponding game sprint, as illustrated in operation 430. For example, the sprint time may be pre-defined (e.g., 90 seconds) for the plurality of game sprints that can be played in the competition game. The sprint time of each game sprint can be varied based on the game play inputs of the player participating in the competition game. For example, the player may place bets to increase the sprint time of a particular game sprint or for all game sprints within the competition game. The competition game specifies a minimum size of bet that needs to be placed by a player to increase the sprint time by a pre-defined increment. For example, the minimum size of bet required to increase the sprint time may be set at 20,000 units of game winnings in order to increase the sprint time of a game sprint by a 30 second increment. Thus, depending on the size of bet placed by a player and depending on the minimum size of bet required, the sprint time of a game sprint may be increased in pre-defined increments. In the above example of a game sprint having a sprint time of 90 seconds, when the player places 60,000 units of game winnings as bet for the game sprint, the sprint time for the game sprint is increased by 90 seconds (30 seconds for each bet size of 20,000 units).

Once the sprint time for the game sprint is determined or set, the player is enabled to participate in one or more game sprints for the competition game, as illustrated in operation 440. As mentioned earlier, the sprint time of each game sprint allows the player to play one or more game turns and a game sprint score is determined for each game sprint, as described below.

Each game sprint is a game play session from which the player obtains a game sprint score. For example, the online game may be a slot game and a time period for the competition game of the slot game may be defined to be 10 hours. The players in each division of the competition game are enabled to participate in multiple game sprints within the 10 hour window. Each player in a division may opt to play for the whole 10 hours or may play for a portion of the 10 hour period. Further, each player in the division may play at different times (asynchronous) or may elect to play at the same time (synchronous) as other players in the division, wherein the players may independently play the competition game for a portion of the time period (e.g., 30 minutes or 1 hour within the 10 hour window). The sprint time of each sprint game of each player in each division may be determined from a size of bet placed by the respective player for the corresponding sprint game. In some implementations, an option may be provided to the player for placing the bet for each game sprint prior to the start of the game sprint. In alternate implementations, an option may be provided to the player for placing the bet for all game sprints of the competition game prior to the start of the competition game.

As each game sprint of the slot game includes one or more game spins, the game sprint score is based on an outcome of the one or more game spin(s) played by the player during sprint time defined for the game sprint. From the above example, the player may perform as many game spins as possible within the 90 seconds defined for a game sprint. When the player increases the sprint time by placing bets, the number of game spins increase accordingly.

In the case of the slot game, the player may initiate a game sprint by selecting a spin option provided at a user interface on a client device used by the player to participate in the competition game. The spin option may be configured to allow the player to perform a single turn or a plurality of turns (i.e., game spins) of the online game during the game sprint. For example, with the single-turn sprint option, the online game execution engine performs a single turn of the online game and waits for the player to provide input to perform additional turns, during the game sprint. As a result, with the single-turn option, the player controls the number of turns to complete with the sprint time of the game sprint. Whereas, with the multi-turn sprint option, the online game execution engine automatically performs a plurality of game turns. The number of game turns performed during a multi-turn game sprint depends on the amount of time taken to complete each game turn and the sprint time of the game sprint. In some implementations, the player may be provided with an option to select between the single-turn sprint option and the multi-turn sprint option.

The game sprint score of each game sprint is collected from the game turns (i.e., game spins) for the player and a highest game sprint score is determined from among the various game sprints played by the player during the time period of the competition game, as illustrated in operation 450. The highest game sprint score of the player is used to dynamically rank the player in the division for the competition game, as illustrated in operation 460. In an asynchronous mode, each player may participate in the competition game at different times during the time period of the competition game. As a result, each player's highest game sprint score is determined at different times and the players in the division are continuously ranked during the timer period of the competition game. The dynamic ranking of the players in each division may be updated to a leaderboard and presented to the players during the competition game. The relative ranking of the player and the division to which the player is assigned are also used to determine game winnings of the overall competition game.

The various implementations describe an option provided in an online game to allow a player to participate in a competition game of an online game and smartly group the player into a division with players having comparable skill set, in order to enhance the player's game play experience. The grouping of the player is done using a hybrid grouping algorithm. Further, the competition game enables the player to participate in a plurality of game sprints within a time allocated for the competition game allowing the player with multiple turns to improve their game winnings. Additional options are provided to the player to increase sprint time of each game sprint by allowing the player to “buy” extra time for the game sprint. It should be noted that the online game execution engine ensures that the extra time bought by the player for a game sprint is within the allocated time period of the competition game.

The hybrid grouping algorithm places a player into a class based on game bets placed by the player during game play of the online game and into a division based on the class to which the player is assigned and the skill set possessed by the player. Such hybrid grouping provides the player to compete with players of comparable skill set at times when the player is placed into a corresponding division, with players having higher skill set when placed into a higher division, and with players having lesser skill set when placed into a lower division.

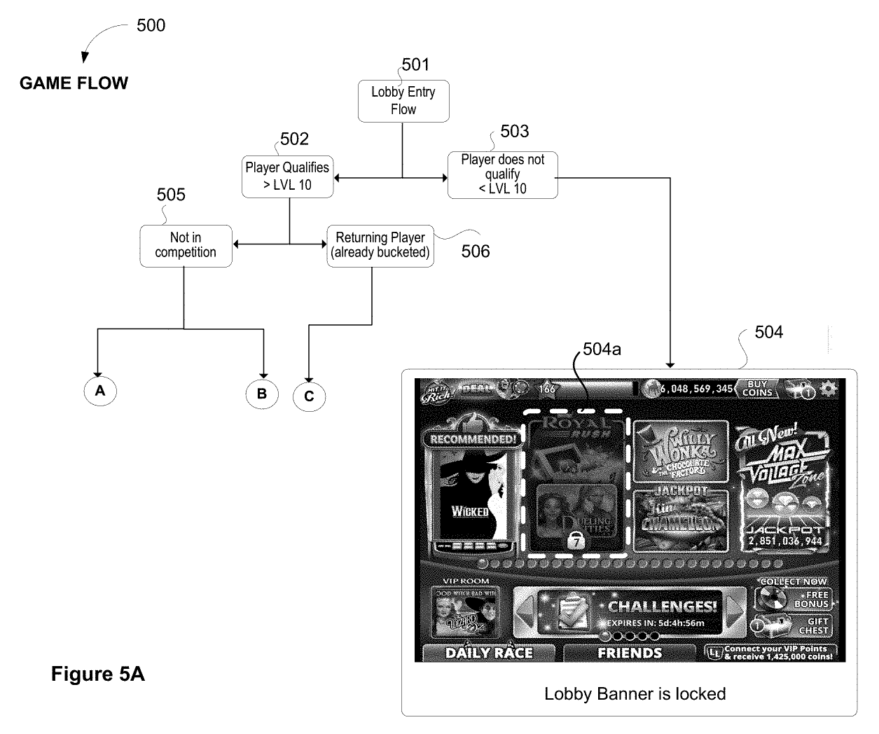

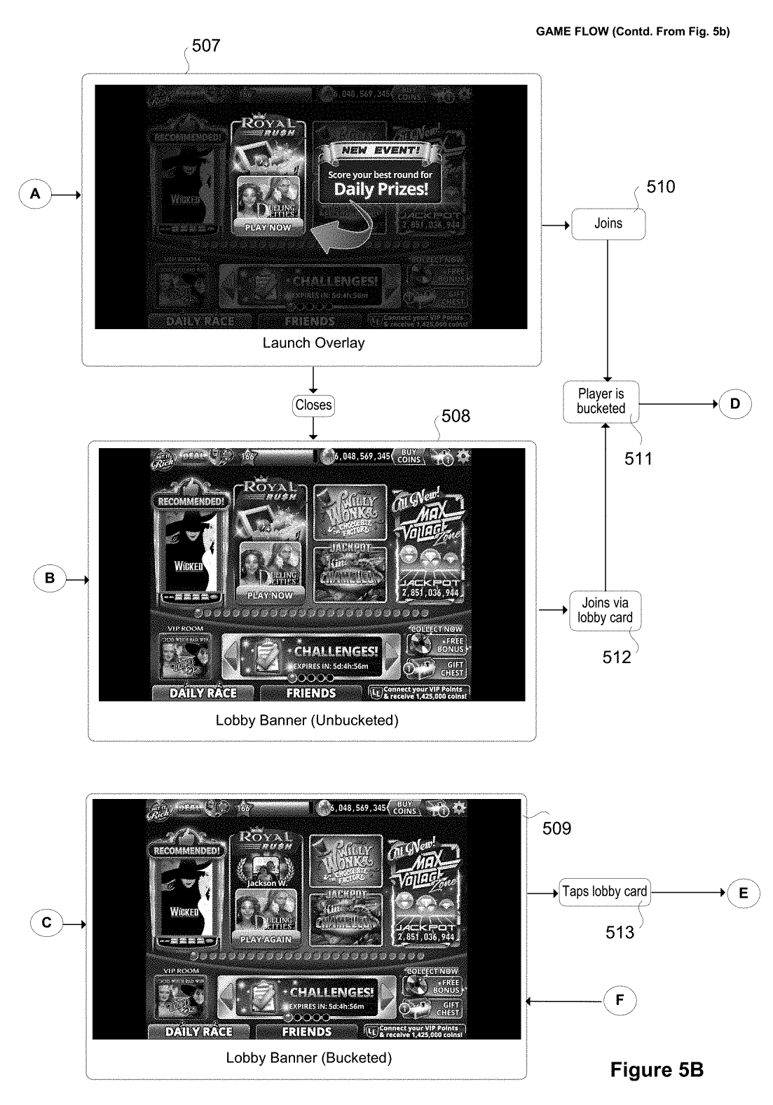

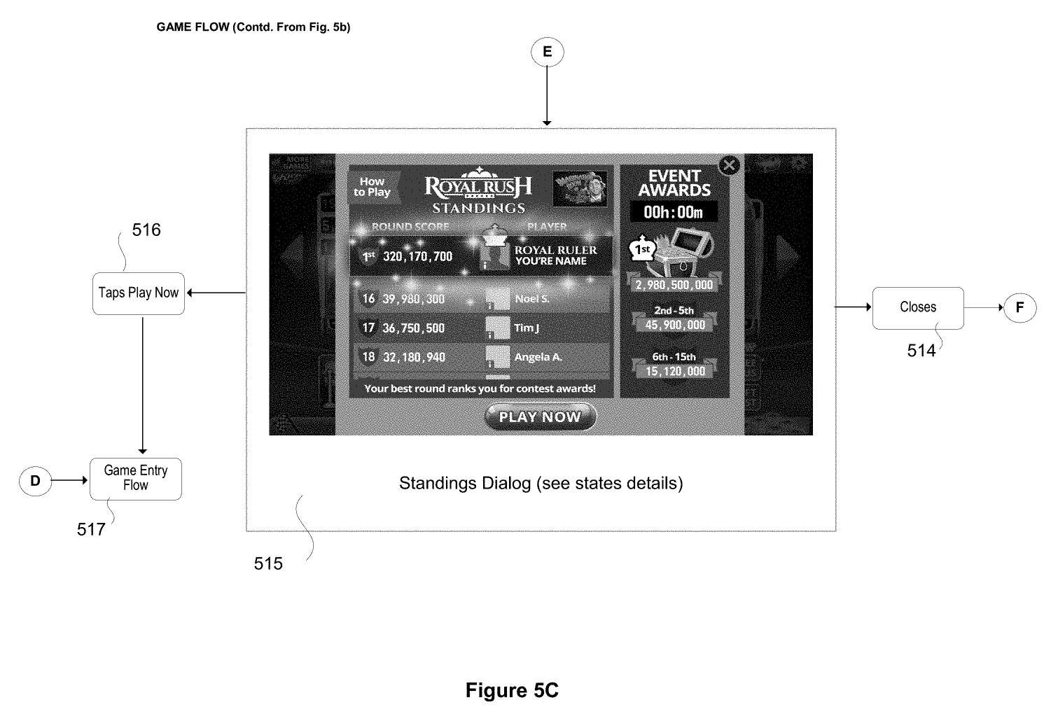

FIGS. 5A-5C illustrate a data flow summary of a method used to provide an option to a player for participating in a competition game, in one implementation. In this implementation, a player can access the various games available to the player account by entering a game “lobby” as shown by box 501. The game lobby is a staging area provided on a webpage by a gaming system, such as a cloud gaming system, for accessing the different games available to a player account within the gaming system. When the player accesses the game lobby, a user interface with icons of a plurality of games available to the player account is provided for player interaction. In alternate implementation, the player may be able to directly access an online game by accessing the game from the player account at the cloud gaming system. In one implementation, the icons of the games may also include a game state (if one exists) of the game of the player and may also include one or more additional details, such as a current leader in the game.

When the user accesses the online game either through the game lobby or directly by accessing the player account, an online game execution engine executing on a server of the cloud system monitors game play of the online game by the player to determine current level of the player and compares it against a qualifying level pre-defined for the online game, as illustrated by box 502. The player is qualified to participate in the competition game for the game when the player has reached at least a certain level in the game, such as level 10 of a 20 level game, for example. Of course, the aforementioned eligibility of the player is provided as a mere example and that other game play attributes of the player may be used to qualify the player. For example, in some implementations, the player may be qualified to participate in the competition game of an online game included in the user interface based on amount of game winnings accumulated by the player during game play of the game. In other implementations, the player may be qualified to participate in the competition game based on the level of the game achieved and the amount of game winnings accumulated.

When it is determined that the player does not qualify for the competition, as shown in box 503, the option to compete with other players is not available to the player. As a result, the player is “locked out” of the competition game by not providing an option to select the competition game. This is shown by a greyed out icon of the online game (e.g., a “Royal Rush” icon representing the competition game option illustrated by white, broken line box 504a) in the user interface 504 illustrated in FIG. 5A. If, on the other hand, the player qualifies for competing with the other players in the competition game, based on the level achieved by the player in the game, as illustrated in box 502, the game execution engine may determine if the player is a new player or a returning player. The player may be a new player, the process flow for the new player follows the path shown by bubble ‘A’. If, on the other hand, the player has played the game previously but has not participated in the competition game, the process flow for the player follows the path shown by bubble T′. If, however, the player has already participated in the competition game, then the process flow for the player follows the path shown by bubble ‘C’.

Referring to FIG. 5B, if the player is a new player (i.e., the player may be newly eligible to compete), as shown by box 505 in FIG. 5A (i.e., path illustrated by bubble ‘A’), an option is provided alongside an activated game icon of the online game (represented by a “Launch Overlay” icon) in the user interface 507 to enable the player to participate in the competition game. The player may select to join the competition game, as illustrated by box 510. In response to the player selecting to join in the competition game, the player is assigned to a particular division to compete with other players, as illustrated by a “bucketing” option 511. The player may be bucketed into one of a plurality of divisions by matching player attributes or game play metrics of the player with the player attributes or game play metrics defined for each division. The player attributes, for example, may include frequency of playing the game, amount of time spent in the game, geo location of the player, number of recommendations provided by or to social contacts, etc. The game play metrics of the player may include skill level, type and average amount of bet the player places for the game every time the player plays the game, amount of game winnings, etc. Once the player is bucketed into a division, the process flow follows the path shown by bubble ‘D’. Referring now to FIG. 5C, the process flow following the path illustrated by bubble ‘D’ allows the player to proceed to enter the competition game by initiating game entry flow 517. Game winnings from the game play are accumulated and the player account of the player is credited with the accumulated game winnings. The bucketing of the player allows the player to participate in a competition with other players, whenever the player selects the competition option provided at the user interface in the game lobby.

Referring back to FIG. 5B, if the player has not yet entered the competition, as illustrated in box 505 (i.e., path illustrated by bubble ‘B’), the player may access the option to participate in the competition game by selecting a lobby “card” of the online game that has the competition game option activated from the lobby user interface 508. At this time, the player is not associated with any particular division for competing with other players. When the player selects the option to participate in the competition by interacting with the lobby card representing the game icon of the online game, as illustrated in box 512, the player is dynamically bucketed into an appropriate division for the competition (box 511), in accordance to the player's game play metrics or player attributes. After the player is “bucketed”, the process flow follows the path shown by bubble ‘D’. Referring to FIG. 5C, the process flow of bubble ‘D’ allows the player to proceed to play the competition game by initiating game entry flow 517.

Referring back to FIG. 5B, if the player is already eligible for participating in the competition game and is a returning player, as illustrated in box 506 (i.e., path illustrated by bubble ‘C’), the player is presented with the user interface of the game lobby 509 that includes game icons of a plurality of games available for the player including the online game for which the option to participate in a competition game is activated. Since the player is a returning player, the player has already been bucketed into a division. When the player selects a lobby card (i.e., taps a lobby card) representing the game icon that includes the option to participate in the competition game (illustrated by box 513), the process flow follows the path illustrated by bubble ‘E’.

Referring to FIG. 5C, the player's current standing in the competition game is shown in a leaderboard in distinct color, such as green, and the leader of the competition game may be shown in another distinct color, such as purple, as illustrated in box 515, to enable the player to quickly distinguish his current ranking in the competition game. The competition game spans a pre-defined period of time, such as 24 hours, 12 hours, etc., and the player may be allowed to participate in the competition game and perform a plurality of game sprints of short duration of time for the time period remaining in the competition game. The sprint time of each game sprint can be adjusted in pre-defined increments by allowing the player to buy extra time for the game sprint. For example, each sprint may have a sprint time of 60 seconds or 90 seconds. The player may be able to increase the sprint time in 30 second increments, for example, by placing an amount of bet for the game sprint. Each additional increment may require same amount of bet as the initial increment or a higher amount of bet than the initial increment. For example, the sprint time of a game sprint may be 60 seconds and the player may place an initial wager of 20,000 game winning units to initially increase the sprint time of a game sprint by a 30 second increment so that the player will get 90 seconds for the game sprint instead of the original 60 seconds. The player can place additional bets to add a second 30 second increment. However, the second increment may require the player to bet 30,000 game winnings units instead of the original 20,000 game winning units. In alternate implementations, the sprint time of each game sprint may be adjusted based on skill level of the player instead of the game winnings.

The player may tap the “Play Now” option in the user interface provided in box 515, as illustrated by box 516. In response to the player selecting the play option, the player proceeds to playing the competition game by initiating game entry flow 517. Presentation of the leaderboard message marks the conclusion of the game sprint, as illustrated in box 514, and the player is returned to the game lobby wherein the player has the option of selecting the game for one or more additional game sprints, as illustrated by bubble ‘F’.

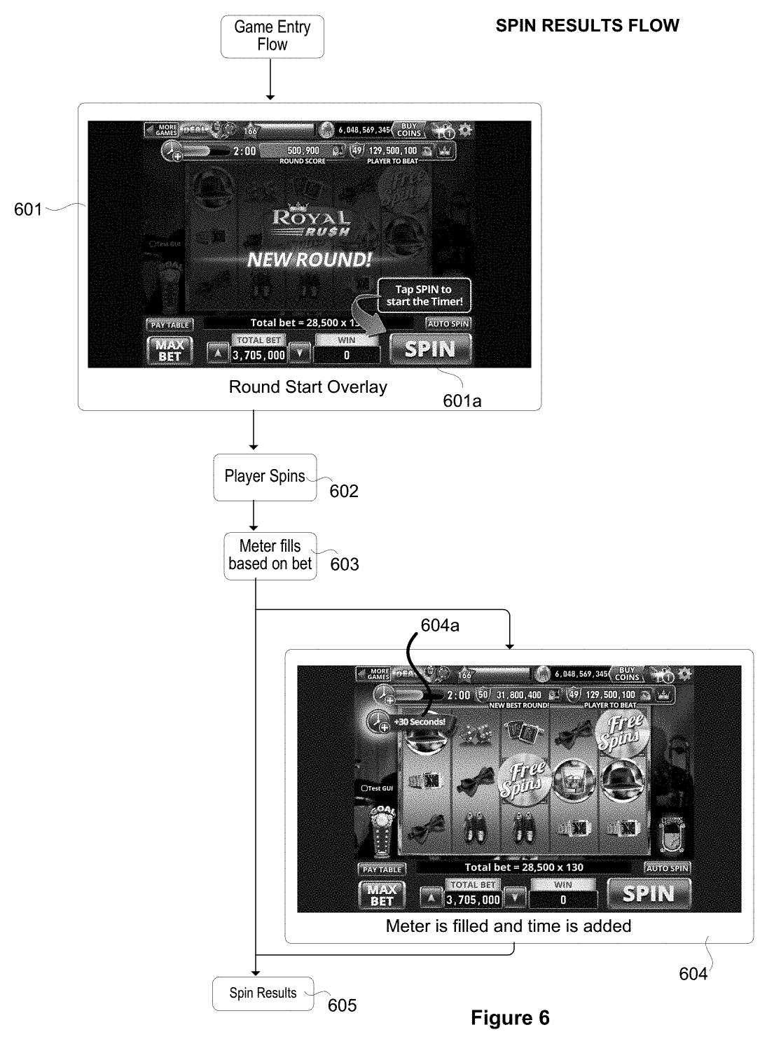

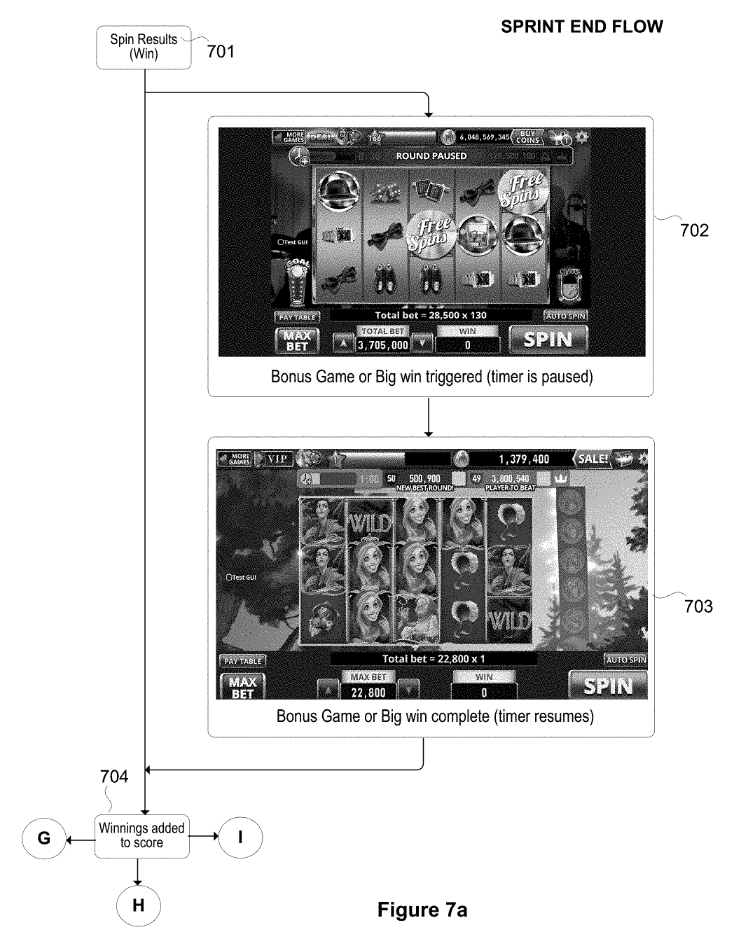

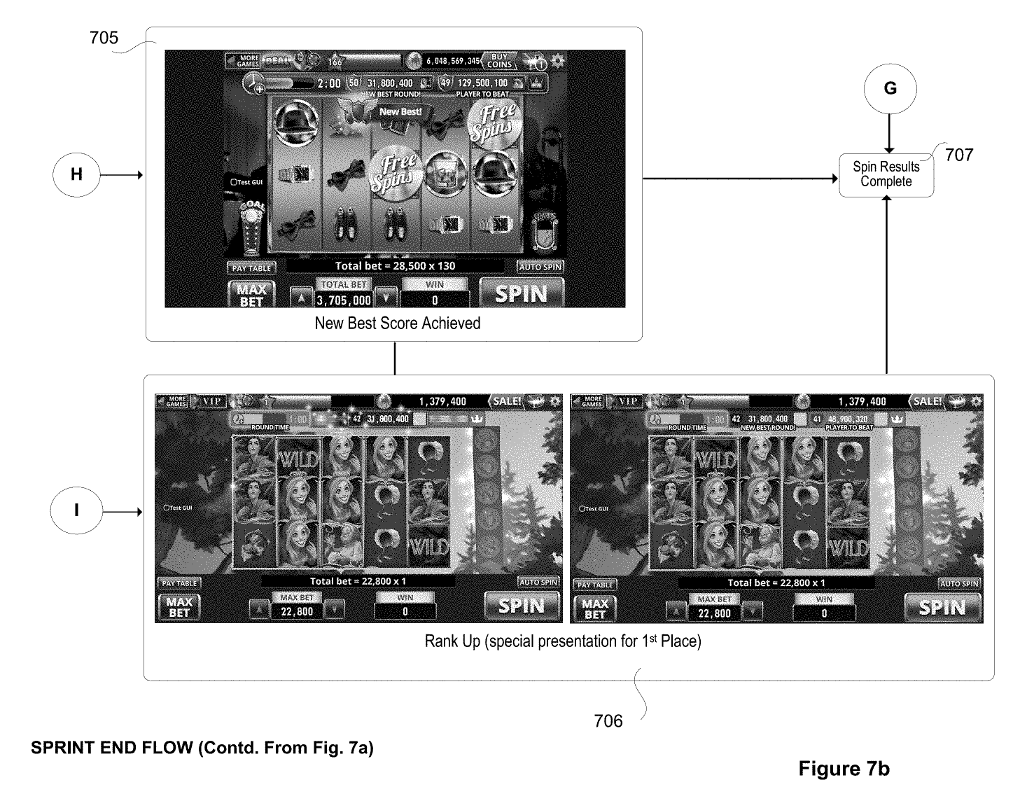

FIG. 6 provides an example illustration of data flow process for playing a game sprint of the competition game, when the game entry flow 517 is selected by the player in FIG. 5. The selection to compete causes an update to the user interface presented to the player. The updated user interface shows a beginning of a new game sprint round (illustrated by “Round Start Overlay” 601) that includes an option (e.g., spin option—601a) to initiate a game turn (i.e., game spin) for the game sprint of the competition game. In one implementation, the option to initiate the game sprint is provided upon conclusion of any previous game sprint(s) initiated by the player. When the player selects the spin option 601a, as illustrated by box 602, the timer of the sprint starts for the player. The player may be able to increase the sprint time by placing a bet. Based on a size of the bet amount, a timer meter for the sprint for the player is filled, as illustrated by box 603. In some implementations, the timer meter is adjusted in pre-defined time increments. The adjusted sprint time allows the player to accumulate as much game winnings as possible for the sprint before the timer runs out. The player is presented with a user interface 604 that shows a game scene and a pre-defined incremental time of 30 seconds, for example, that was added to the sprint time based on the bet placed by the player. Since the timer is adjusted upward the player has additional time to increase his game winnings for the competition game. The spin results from the game sprint (illustrated by box 605) are updated to the game winnings of the player. Details of how the spin results of the sprint are used to update the game winnings and to rank the player will be discussed with reference to FIGS. 7A-7B.

FIGS. 7A-7B provide an example of computing spin results for a game sprint played by a player during the competition game that includes game winnings of a bonus game triggered for the player, in one implementation. In some implementation, a bonus game may be triggered to allow the player to improve their game winnings. The triggering may be initiated upon detecting the player's game play inputs (e.g., various bets placed) or upon detecting that the game winnings of the player is dwindling or to provide an option to just increase the player's game winnings in the game sprint. The bonus game may be triggered during the competition game while the player is participating in a game sprint or prior to the start of a game sprint or in-between two game sprints. Alternately, a bonus game option may be provided at the user interface of the client device, which when interacted by the player initiates the bonus game. Referring to FIG. 7A, when the bonus game is triggered/initiated during the game sprint, for example, the timer meter for the game sprint is paused, as shown in the user interface 702 of the competition game, to allow the player to complete the bonus game. Upon completion of the bonus game, the timer meter for the game sprint is resumed to allow the player to complete the game sprint, as illustrated in the user interface 703. Winnings from the bonus game are added to the game score (i.e., game winnings) accumulated for the game sprint of the player, as illustrated in operation 704. The game winnings from the bonus game may result in the player achieving a new best score and/or ranking in the competition game, as illustrated by various flow paths defined by bubbles ‘G’, ‘H’, and ‘I’, respectively.

Referring to FIG. 7B, the game winnings from the bonus game may be added to the score and the amount of time used for playing the bonus game may result in the expiration of time period for the competition game or may result in not having sufficient time to play another game sprint. As a result, the process flow follows the path of bubble ‘G’, wherein the game winnings from the bonus game are added to the overall game winnings for the competition game, as illustrated in operation 707. Alternately, the game winnings from the bonus game may result in the player achieving a new best score for the game sprint (bubble ‘H’), as illustrated in the user interface 705. The new best score may not change the ranking of the player. Still further, the game winnings of the player for the game sprint may result in adjusting the ranking of the player (bubble ‘I’). For example, the winnings of the player for the game sprint that includes the bonus game winnings may result in the player's ranking within the division of the game being adjusted upward, as illustrated in the user interface 706. The adjustment in the ranking of the player, in some instances, may result in the player achieving a top ranking (i.e., first place) for the game sprint. The flow of operations for the game sprint ends with the results of spin for the game sprint being used to adjust the overall winnings of the competition game (and the overall ranking of the player), as illustrated by operation 707.

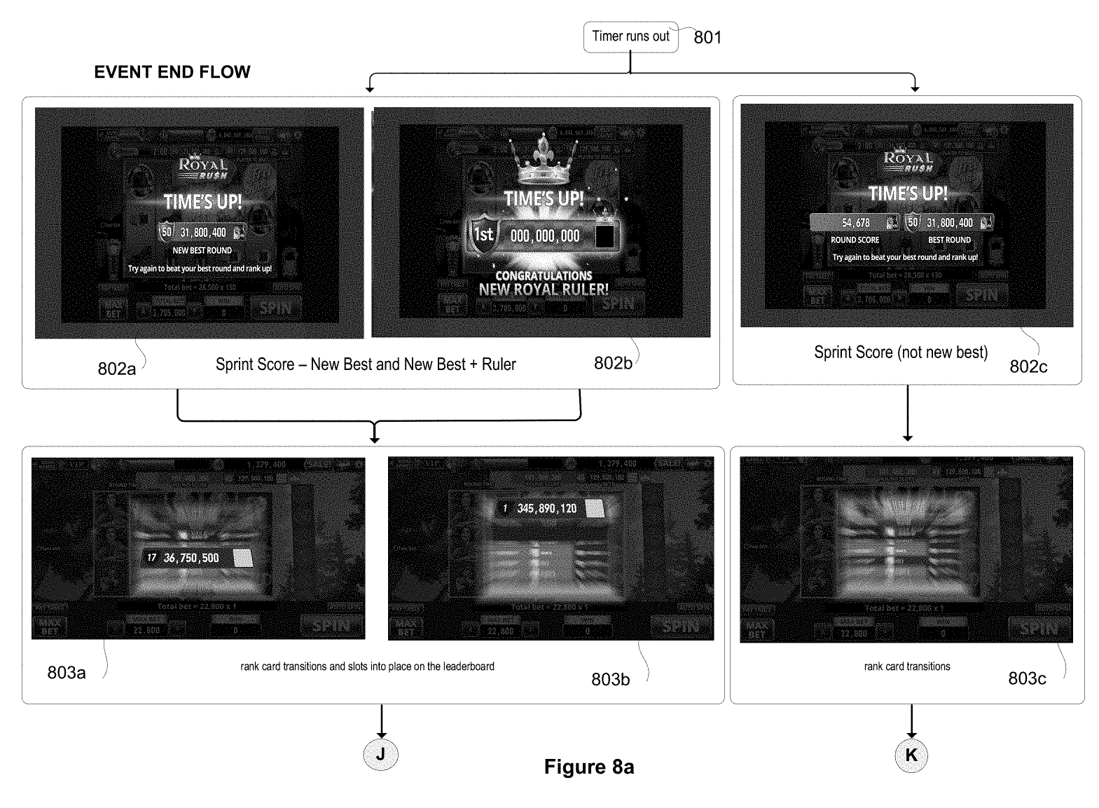

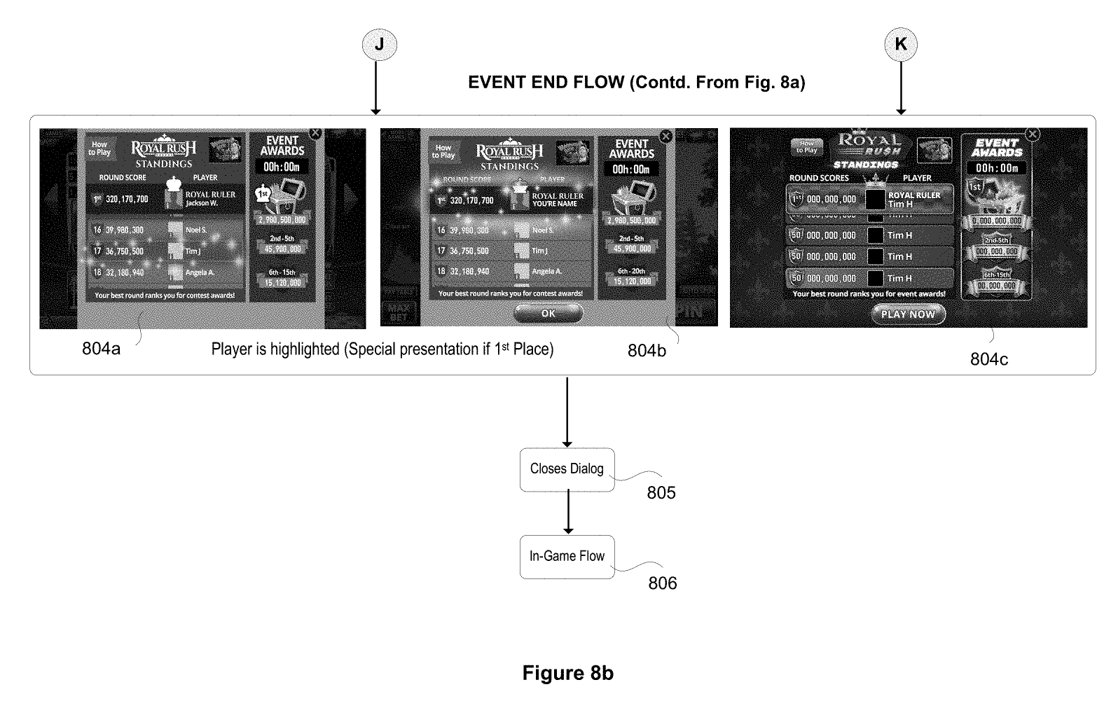

FIGS. 8A-8B illustrate data flow at the end of an event (i.e., game sprint event) that identifies the various outcomes of a game sprint for the player, in one implementation. The outcome of the game sprint is determined when the sprint time for the game sprint runs out, as illustrated in operation 801. Based on the winnings accumulated for the player during the game sprint, the player may have achieved their best sprint score, as illustrated by the “New Best Round” in the user interface 802a or may have achieved their top sprint score and may be the ruler, as illustrated in the user interface 802b. Alternately, the player may not have achieved their best score during the current game sprint. In such a case, the user interface would provide the sprint score (i.e., round score) accumulated for the player for the current game sprint as well as the player's best round score obtained from an earlier game sprint in the competition game, as illustrated in the user interface 802c.

Irrespective of the outcome of the game sprint, the user interface presented to the player is transitioned from icons or game scenes of the online game(s) to a leaderboard to show the current ranking of the players in the division, as illustrated by the various transitions shown in user interfaces 803a-803c. The user interface in 803a depicts card transitions and slot placement of the player based on the new rank of the player. The new rank of the player identifies the current slot position of the player to be 17 on the leaderboard. User interface in 803b depicts card transitions and current slot placement of the player on the leaderboard based on the player's first place ranking (i.e., Royal Ruler). User interface 803c depicts only cards being transitioned and no slot placement for the player. This may be due to the fact that the player, who previously ranked within the top 50 before this game sprint, failed to beat his best score (as depicted in user interface 802c) in this game sprint. As a result, no slot placement happens for the player. Alternately, the player may have beaten his best score but still failed to place within the top 50. As a result, the user interface presented to the player includes only cards transition and no slot placement on the leaderboard. From user interface 803a, 803b, the process flow follows the path represented by bubble T and for user interface 803c, the process flow follows the path represented by bubble ‘K’.

Referring to FIG. 8B, once the user interface transition is completed (803a, 803b) (i.e., following path represented by bubble ‘J’), the player is presented with a user interface (804a) rendering the leaderboard with the current ranking (rank 17) of the player in the division, which is determined based on an outcome of the current sprint game. The player's ranking may be highlighted in distinct color on the leaderboard to enable the player to easily notice his current standing for the competition game amongst other players in the division. In some implementation, if the player does not improve his ranking within the division, the player may elect to play additional game sprints so long as such game sprints can be performed within the allocated time period defined for the competition game. In such implementations, an option (not shown) may be provided in the user interface 804a to allow the player to play additional game sprints to improve his ranking within the division. When not enough time is available within the competition game, the option to play additional game sprints may not be shown in the user interface 804a. Winnings from the additional game sprints may be used to rank the player in the leaderboard. When the winnings from the sprint cause the player to be ranked at the top (804b), the leaderboard may provide special animation to highlight the achievement of the player. The player does not need to participate in additional sprints since the player ranked at the top. If however the player did not rank within the top 50 players (see user interfaces 802c and 803c) (i.e., following path represented by bubble ‘K’), the leaderboard presented in the user interface 804c of the player may, in some implementation, identify the current Royal Ruler, initialize the leaderboard, and present the name of the current Royal Ruler in all the card slots on the leaderboard. Further, depending on the amount of time left within the competition game, the user interface 804c may provide an option to the player to play again to allow the player to improve his ranking. When the time for the competition game ends, the game sprint dialog closes the user interface, as illustrated in operation 805 and the player is allowed to continue with the regular game flow of the online game, as illustrated in operation 806.

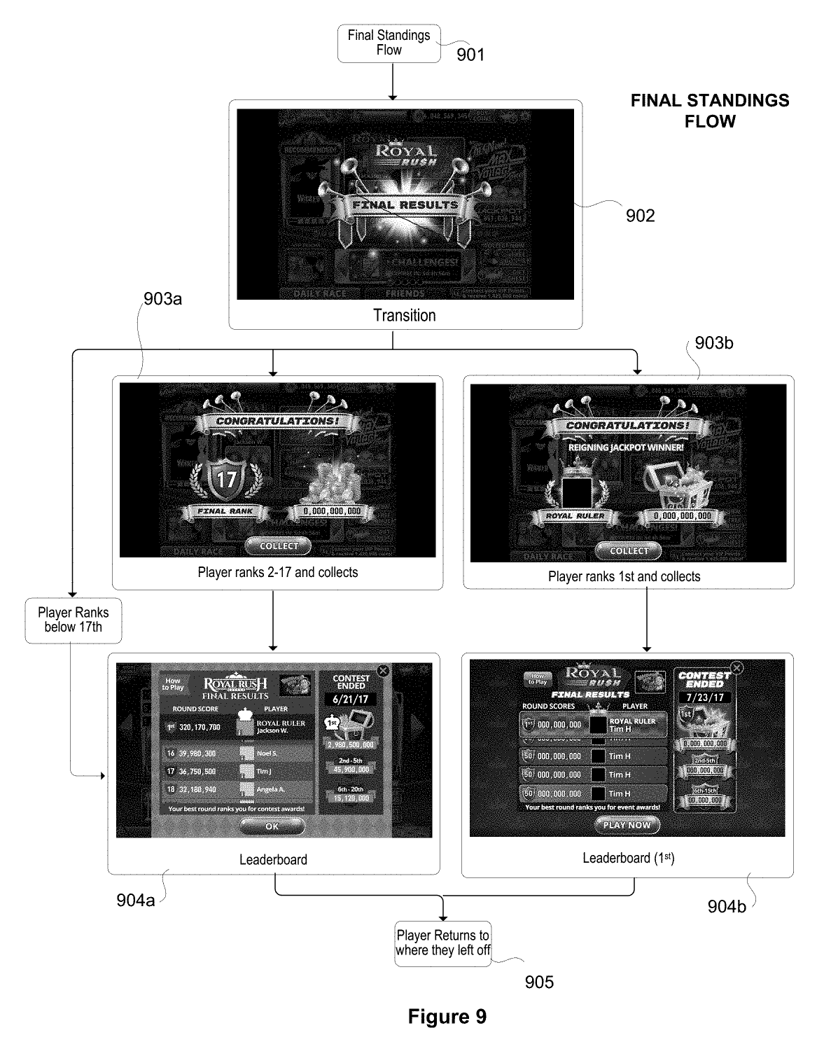

FIG. 9 illustrates an example of final standings flow of operations for a competition game in which the player participated, in one implementation. The final standings flow starts at operation 901, when the winnings of the player accumulated during different game sprints of the competition game are collected to determine the best score of the player. Based on the accumulated winnings, the user interface transitions to a final standing user interface (902) highlighting the game icon. In some implementations, when the player ranks within top 17 players in the division for the game sprint, the player is allowed to collect the game winnings, as illustrated in the user interface 903a. The player's current ranking is updated to the leaderboard presented at the user interface 904a. The current ranking of the player may be highlighted in a distinct color (e.g., green) when presented to the player. Upon presenting the leaderboard for the competition game, the player is allowed to return to playing the online game from where the player left off when they entered the competition game and participated in multiple game sprints, as illustrated in operation 905.

When the player ranks at the top, the player is designated the “ruler” of the competition game, as illustrated in the user interface 903b, and the player is allowed to collect the game winnings associated with the ruler of the game. The collection of the game winnings may include updating the player account of the player with the game winnings from the game sprint. In addition to allowing the player to collect the game winnings, the leaderboard is dynamically updated to show the player's ranking at the top of the division (i.e., ranked first) for the game sprint, as illustrated in 904b. The highest rank of the player may be highlighted in distinct color (e.g., purple) on the leaderboard to enable the player to quickly identify their current ranking. The player is then allowed to return to playing the online game from where the player left off when they entered the competition game and participated in multiple game sprints, as illustrated in operation 905.

When the player ranks below top 17 in the division, the user interface presented for the player for the sprint includes the current ranking of the player in distinct color, as illustrated in user interface 904a. The player is then allowed to return to resume game play of the online game from the point where the player left off to compete with other players, as illustrated in operation 905.

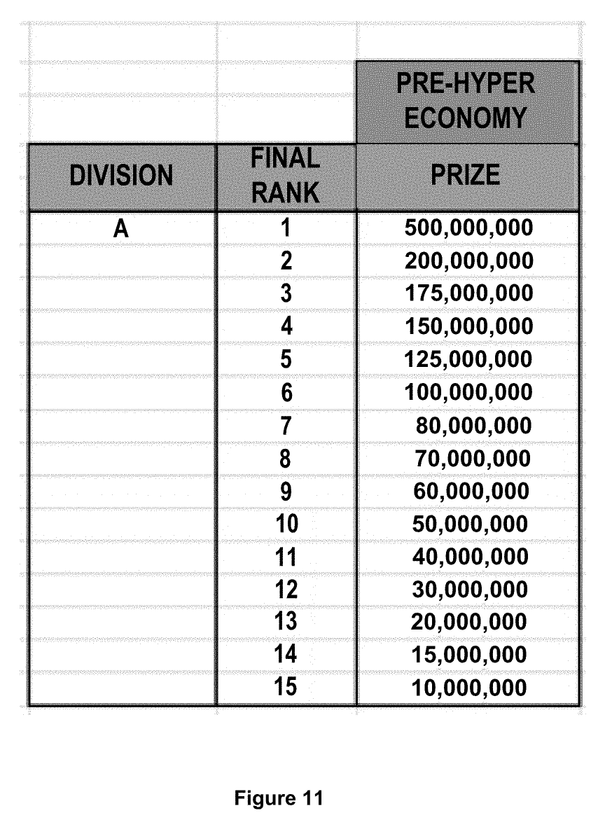

FIG. 11 illustrates an example payout for each player in a division, in one implementation. The amount of payout may be based on the class of the player in the competition game, as each division may have its own payout structure with the lower ranked divisions paying out less than the higher ranked divisions. For example, players in division A, which is the top ranked division, may be provided with a higher payout for each ranked player than the players in division B, which is next in the ranking scale, players in division B may be provided with a higher payout for each ranked player than players in division C, and so on. The payout may be defined based on the player attributes, game play metrics of the players, etc. In alternate implementation, the payout for the players may be the same for each division identified in the competition game.

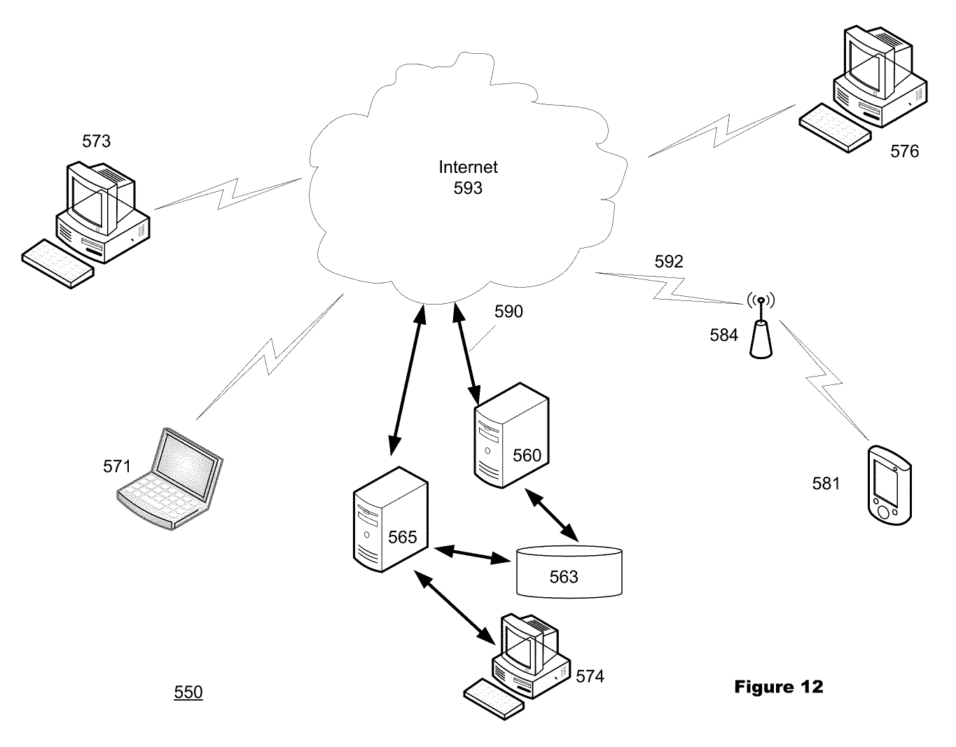

FIG. 12 illustrates an exemplary hardware configuration for implementing a system according to an embodiment of the present invention. The system 550 may comprise one or more networked servers 560 and 565, one or more player computing devices (i.e., client devices) 571, 573, 574 and 576, portable player computing device(s) 581, data storage devices 563, wired and wireless communication links 590, 592, and wireless access point 584. Of course, the above list of components of the system 550 is provided for illustration purposes and should not be considered exhaustive. The one or more networked servers 560 and 565 may execute a multi-application software system that may include a web server, gaming software applications and social networking applications. The servers 560, 565 may include processor(s), internal memory and related computer program instructions (all not shown). The player computers 571, 573, 574, 576 may include a processor, display device, and data storage device, such as a hard disk (all not shown).

The server 560 and/or 565 may provide connectivity between the players' computing devices 571, 573, 574 and 576, and/or players' portable computing device(s) 581 over wired or wireless communication paths. The server 560 may access data storage device(s) 563 that store machine-readable software instructions for executing the described method which may be accessed and executed by the processor(s) of the server 560. The instructions for generating and presenting may be downloaded to players' computers 571, 573, 574 and 576, and/or players' portable device(s) 581 over wired or wireless communication paths. The game software may execute on the processors in the players' computers 571, 573, 574 and 576, and/or players' portable computing device(s) 581.

The data storage device(s) 563 also may store data related to the players for future use. The data storage device 563 that may be a hard disk drive, non-volatile memory, flash memory, or any suitable device for storing electronic data, and may be organized as an object-oriented or relational database.

The servers 560 and 565 may communicate with client terminal(s) 571, 573, 574, 576 and portable device(s) 581 via the internet 592. The player computers 571, 573, 574, 576 may include a processor, display device, and data storage device, such as a hard disk (all not shown). The client terminals 571, 573, 574, 576 may participate in execution of program instructions. The portable device 581 may be a smartphone, personal digital assistant, tablet, notebook or mini-notebook computer capable of wired and/or wireless communication. The portable device 581 may include memory, a processor, input device, display, and devices that enable wired or wireless communication.

It is noted that the embodiment illustrated in FIG. 12 is an exemplary online gaming infrastructure. Other embodiments may utilize different types of servers, databases, APIs, etc., and the functionality of several servers can be provided by a single server, or the functionality can be spread across a plurality of distributed servers. The embodiment illustrated in FIG. 12 should therefore not be interpreted to be exclusive or limiting, but rather exemplary or illustrative.

An example network environment suitable for implementing embodiments will be described now. Network environment includes a network coupling one or more servers and one or more client devices to each other. In particular embodiments, network is an intranet, an extranet, a virtual private network (VPN), a local area network (LAN), a wireless LAN (WLAN), a wide area network (WAN), a metropolitan area network (MAN), a portion of the Internet, another network, or a combination of two or more such networks.

One or more links couple a server or a client device to network. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links.

Each server may be a stand-alone server or may be a distributed server spanning multiple computers or multiple datacenters. Servers may be of various types, such as, for example and without limitation, community server, web server, news server, mail server, message server, advertising server, file server, application server, exchange server, database server, or proxy server. Each server may include hardware, software, embedded logic components, or a combination of two or more such components for carrying out the appropriate functionalities implemented or supported by server. For example, a web server is generally capable of hosting websites containing web pages or particular elements of web pages. More specifically, a web server may host HyperText Markup Language (HTML) files or other file types, or may dynamically create or constitute files upon a request, and communicate them to clients in response to Hypertext Transfer Protocol (HTTP) or other requests from clients. A mail server is generally capable of providing electronic mail services to various clients. A database server is generally capable of providing an interface for managing data stored in one or more data stores.

In particular embodiments, one or more data storages may be communicatively linked to one or more severs via one or more links. Data storages may be used to store various types of information. The information stored in data storages may be organized according to specific data structures. In particular embodiments, each data storage may be a relational database. Particular embodiments may provide interfaces that enable servers or clients to manage, e.g., retrieve, modify, add, or delete, the information stored in data storage.

In particular embodiments, each client device may be an electronic device including hardware, software, or embedded logic components or a combination of two or more such components and capable of carrying out the appropriate functionalities implemented or supported by client. For example and without limitation, a client device may be a desktop computer system, a notebook computer system, a notebook computer system, a handheld electronic device, or a mobile telephone. A client device may enable a network player at client device to access network. A client device may enable its player to communicate with other players at other clients devices. Further, each client device may be a computing device, such as a desktop computer or a work station, or a mobile device, such as a notebook computer, a network computer, or a smart telephone.

In particular embodiments, a client device may have a web browser, such as Microsoft Internet Explorer, Google Chrome, Or Mozilla Firefox, and may have one or more add-ons, plug-ins, or other extensions. A player at client device may enter a Uniform Resource Locator (URL) or other address directing the web browser to a server, and the web browser may generate a Hyper Text Transfer Protocol (HTTP) request and communicate the HTTP request to server. Server may accept the HTTP request and communicate to client device one or more Hyper Text Markup Language (HTML) files responsive to the HTTP request. Client device may render a web page based on the HTML files from server for presentation to the user. The present disclosure contemplates any suitable web page files. As an example and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in Javascript, Java, Microsoft Silverlight, combinations of markup language and scripts such as AJAX (Asynchronous Javascript and XML), and the like. Herein, reference to a web page encompasses one or more corresponding web page files (which a browser may use to render the web page) and vice versa, where appropriate.

Web browser may be adapted for the type of client device where the web browser executes. For example, a web browser residing on a desktop computer may differ (e.g., in functionalities) from a web browser residing on a mobile device. A user of a social networking system may access the website via web browser.

An example computer system for implementing embodiments will now be described. In particular embodiments, software running on one or more computer systems performs one or more operations of one or more methods described or illustrated herein or provides functionality described or illustrated herein. Although methods for implementing embodiments were described with a particular sequence of operations, it is noted that the method operations may be performed in different order, or the timing for the execution of operations may be adjusted, or the operations may be performed in a distributed system by several entities, as long as the processing of the operations are performed in the desired way.

As example and not by way of limitation, computer system may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, computer system may include one or more computer systems; be stand-alone or distributed; span multiple locations; span multiple machines; or reside in a cloud, which may include one or more cloud components in one or more networks. The one or more computer systems may perform in real time or in batch mode one or more operations of one or more methods described or illustrated herein.

In particular embodiments, computer system includes a processor, memory, storage, an input/output (I/O) interface, a communication interface, and a bus. Although this disclosure describes and illustrates a particular computer system having a particular number of particular components in a particular arrangement, embodiments may be implemented with any suitable computer system having any suitable number of any suitable components in any suitable arrangement.

In particular embodiments, processor includes hardware for executing instructions, such as those making up a computer program. As an example and not by way of limitation, to execute instructions, processor may retrieve (or fetch) the instructions from an internal register, an internal cache, memory, or storage; decode and execute them; and then write one or more results to an internal register, an internal cache, memory, or storage. The present disclosure contemplates processor including any suitable number of any suitable internal registers, where appropriate. Where appropriate, processor may include one or more arithmetic logic units (ALUs); be a multi-core processor; or include one or more processors. Although this disclosure describes and illustrates a particular processor, this disclosure contemplates any suitable processor.

In particular embodiments, memory includes main memory for storing instructions for processor to execute, or data that can be manipulated by processor. As an example and not by way of limitation, computer system may load instructions from storage or another source (such as, for example, another computer system) to memory. Processor may then load the instructions from memory to an internal register or internal cache. During or after execution of the instructions, processor may write one or more results (which may be intermediate or final results) to the internal register or internal cache. Processor may then write one or more of those results to memory. One or more memory buses (which may each include an address bus and a data bus) may couple processor to memory. Bus may include one or more memory buses, as described below. One or more memory management units (MMUs) reside between processor and memory and facilitate accesses to memory requested by processor. Memory includes random access memory (RAM).

As an example and not by way of limitation, storage may include a Hard Disk Drive (HDD), a floppy disk drive, flash memory, an optical disc, a magneto-optical disc, magnetic tape, or a Universal Serial Bus (USB) drive or a combination of two or more of these. Storage may include removable or non-removable (or fixed) media, where appropriate. In particular embodiments, storage includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these.

In particular embodiments, I/O interface includes hardware, software, or both providing one or more interfaces for communication between computer system and one or more I/O devices. One or more of these I/O devices may enable communication between a person and computer system. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these.

Communication interface includes hardware, software, or both providing one or more interfaces for communication between computer system and one or more other computer systems on one or more networks. As an example and not by way of limitation, communication interface may include a network interface controller (NIC) or network adapter for communicating with an Ethernet or other wire-based network or a wireless NIC (WNIC) or wireless adapter for communicating with a wireless network, such as a WI-FI network. As an example, computer system may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these.

In particular embodiments, bus includes hardware, software, or both coupling components of computer system to each other. As an example and not by way of limitation, bus may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or another suitable bus or a combination of two or more of these. Bus may include one or more buses, where appropriate. Although this disclosure describes and illustrates a particular bus, this disclosure contemplates any suitable bus or interconnect.

Herein, reference to a computer-readable storage medium encompasses one or more non-transitory, tangible computer-readable storage media possessing structure that may store a computer program or data. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a Secure Digital card, a Secure Digital drive, or another suitable computer-readable storage medium or a combination of two or more of these, where appropriate. Herein, reference to a computer-readable storage medium excludes any medium that is not eligible for patent protection under 35 U.S.C. § 101.

One or more embodiments can also be fabricated as computer readable code on a non-transitory computer readable medium. Herein, reference to software may encompass one or more applications, bytecode, one or more computer programs, one or more executables, one or more instructions, logic, machine code, one or more scripts, or source code, and vice versa, where appropriate.

The present disclosure encompasses all changes, substitutions, variations, alterations, and modifications to the example embodiments herein that a person having ordinary skill in the art would comprehend.

1. A method, comprising:
monitoring game play of a player for an online game to determine the player has reached a threshold level that qualifies the player to participate in a competition game;
determining a class for the player based on a history of game play of the player;
assigning the player to a division of players, based on the class of the player, the division defines a group of players for participating in the competition game;
setting a time period for the competition game;
enabling the player to participate in a plurality of game sprints during the time period, wherein each game sprint is a game session during which a game sprint score is obtained; and
determining a highest game sprint score of the player received for the plurality of game sprints that were played by the player during the time period, the highest game sprint score defining a current ranking of the player in the competition game among the group of players in the division.

2. The method of claim 1, further includes enabling additional game sprints for the competition game for the player, upon determining the time period for the competition game has not expired, each additional game sprint associated with a corresponding game sprint score, the game sprint scores obtained by the player during the additional game sprints used in dynamically updating the current ranking of the player in the division.

3. The method of claim 1, further includes,
continuously evaluating time left in the time period for the competition game;
enabling an additional game sprint when the time left is at least greater than a sprint time required to complete the additional game sprint; and
dynamically updating the current ranking of the player in the division based on game sprint score obtained from the additional game sprint.

4. The method of claim 1, wherein each game sprint is defined by a sprint time that is variable.

5. The method of claim 4, wherein the sprint time of a game sprint is varied by dynamically adjusting the sprint time by a pre-defined increment based on a size of game bet provided by the player for the game sprint.

6. The method of claim 1, wherein the class is one of a plurality of classes, wherein each class of the plurality of classes is defined based on average size of bets placed over a period of time, with a higher class being associated with a higher average size of bet and a lower class being associated with a lower average size of bet.

7. The method of claim 1, wherein determining a class of the player further includes,
establishing an analysis period for analyzing the history of game play of the online game by the player;
analyzing the history of game play of the player to identify size of bets placed by the player for the online game during the analysis period, wherein the analysis period includes one or more game play sessions of the online game of the player; and
computing an average size of bet from the size of bets of the player, the average bet used in identifying the class of the player.

8. The method of claim 1, wherein each player of the group of players is assigned to the division based on skill levels possessed by each player.

9. The method of claim 1, wherein when the player is in a top class, the player is assigned to a top division.

10. The method of claim 1, wherein when the player is in a bottom class, the player is assigned to a bottom division.

11. The method of claim 1, wherein when the player is in the class that is between a top class and a bottom class, the player is randomly assigned to one of two divisions that are between a top division and a bottom division, the two divisions identified based on the skill levels possessed by the player.

12. The method of claim 1, wherein determining a class of the player further includes,
determining game winnings accumulated by the player during game play of the online game; and
computing a qualifying bet as a pre-defined percentage of the game winnings of the player, the qualifying bet used in identifying the class of the player.

13. The method of claim 1, wherein one or more game sprints of the plurality of game sprints includes an option to trigger a bonus game for the player during execution of the corresponding one or more game sprints, the bonus game of a game sprint is associated with a bonus game score that is updated to the game sprint score of the game sprint upon completion of the bonus game.

14. The method of claim 13, wherein when the bonus game is triggered during the game sprint, the triggering causes,
pausing of the sprint time of the game sprint to complete the bonus game; and
resuming the sprint time of the game sprint after completion of the bonus game.

15. A method, comprising:
monitoring game play of a player for an online game to obtain current game state of the player, the current game state used to detect the player reaching a threshold level of the online game that qualifies the player to participate in a competition game;
analyzing history of game play of the player to determine a size of game winnings of the player collected during game play of the online game;
determining a class for the player based on the size of game winnings;
assigning the player to a division of players, based on the class of the player, the division defines a group of players for participating in the competition game;
enabling the player to participate in a plurality of game sprints during a time period set for the competition game, wherein each game sprint is a game session during which a game sprint score is obtained; and
determining a highest game sprint score of the player received for the plurality of game sprints that were played by the player during the time period, the highest game sprint score defining a current ranking of the player among the group of players in the division.

16. The method of claim 15, wherein the class of the player is determined by computing a qualifying bet for the player as a pre-defined percentage of the size of game winnings of the player.

17. The method of claim 15, wherein the class is one of a plurality of classes, wherein each class of the plurality of classes is defined based on size of game winnings, with a higher class being associated with a higher game winning and a lower class being associated with a lower game winning.

18. The method of claim 15, wherein player is assigned to one of two divisions in the class using random assignment, the two divisions identified based on the size of game winnings of the player.

19. The method of claim 15, wherein a game sprint of the plurality of game sprints includes an option to trigger a bonus game during execution of the game sprint, the bonus game of the game sprint is associated with a bonus game score that is updated to the game sprint score of the game sprint upon completion of the bonus game.

20. The method of claim 19, wherein triggering the bonus game during the game sprint causes,
pausing of a sprint time of the game sprint;
executing the bonus game; and
resuming the sprint time of the game sprint after completion of the bonus game.

21. A non-transitory computer-readable storage medium storing a computer program for performing a method, the computer-readable storage medium comprising:
program instructions for monitoring game play of a player for an online game to determine the player has reached a threshold level that qualifies the player to participate in a competition game;
program instructions for determining a class for the player based on a history of game play of the player;
program instructions for assigning the player to a division of players, based on the class of the player, the division defines a group of players for participating in the competition game;
program instructions for setting a time period for the competition game;
program instructions for enabling the player to participate in a plurality of game sprints during the time period, wherein each game sprint is a game session during which a game sprint score is obtained; and
program instructions for determining a highest game sprint score of the player received for the plurality of game sprints that were played during the time period, the highest game sprint score defining a current ranking of the player among the group of players in the division.

22. The storage medium of claim 21, wherein each game sprint is defined by a sprint time that is variable, the storage medium including program instructions for dynamically adjusting the sprint time of a game sprint by a pre-defined increment based on a size of game bet provided by the player for the game sprint.

23. The storage medium of claim 21, wherein program instructions for enabling one or more game sprints further includes program instructions for enabling a bonus game during a game sprint, the bonus game associated with a bonus game score that is updated to the game sprint score of the game sprint upon completion of the bonus game.
